(19) United States
(12) Patent Application Publication
(10) Pub. No.: US 2026/0228476 A1
(43) Pub. Date: Aug. 6, 2026

(54) METHODS AND PRINTING SYSTEM FOR INTERACTIVE CONSUMABLE USE ESTIMATION

(71) Applicant: Kyocera Document Solutions Inc., Osaka (JP)

(72) Inventor: Javier A. MORALES, Rochester, NY (US)

(73) Assignee: Kyocera Document Solutions Inc., Osaka (JP)

(21) Appl. No.: 19/046,998

(22) Filed: Feb. 6, 2025

(51) Int. Cl. G06K 15/02

(52) U.S. Cl. CPC G06K 15/1823; G06K 15/1805

(57) ABSTRACT

A printing system includes a printing device having a digital front end (DFE) and an estimation system. A paper catalog for the printing device is accessible by the DFE. The printing system also includes a user interface for the printing device. The system performs an initial consumable estimation of a consumable for a job to be printed at the printing device based on a media. A plurality of print conditions is identified corresponding to a paper catalog entry for the media within the paper catalog. Additional consumable estimations for the media are determined corresponding the plurality of print conditions. A comparison of the overall consumable estimations are generated and displayed within the user interface.

### FIELD OF THE INVENTION

The present invention relates to a printing system and associated methods to provide interactive consumable use estimation for a print job. More particularly, the present invention relates to an interactive consumable use estimation system that allows users to view consumable use estimates for different job processing options.

### DESCRIPTION OF THE RELATED ART

Production printing operations typically involve ink or toner estimation. For large print jobs of 1000s or more documents, the ink and toner use can be considerable. Accurate estimates become important to adequately price the print jobs. Two ways may be used to estimate ink or toner use. One is inline with the digital front end (DFE) of the printing device. The DFE raster image processes the print job in the raster image processor (RIP) to estimate the ink and toner use. An offline process also may be used. An estimation application provides the estimates. Depending on the type, the estimation application will either look at the colors in a job file for the print job and estimate ink or toner use or it will raster image process the file offline to estimate ink or toner use.

### SUMMARY OF THE INVENTION

A method for managing printing operations is disclosed. The method includes performing an initial consumable estimation of a consumable for a job to be printed at a printing device. The job specifies a media. The method also includes identifying a plurality of print conditions corresponding to a paper catalog entry for the media within a paper catalog accessible by the printing device. The method also includes determining additional consumable estimations for the media corresponding to the plurality of print conditions based on information within the paper catalog entry. The method also includes generating a comparison of overall consumable estimations including the initial consumable estimation and the additional consumable estimations. The method also includes displaying the comparison of the overall consumable estimations including the initial consumable estimation and the additional consumable estimations within a user interface for the printing device.

In some embodiments, the consumable is ink. In other embodiments, the consumable is toner. In additional embodiments, the method also includes receiving the job at a digital front end (DFE) of the printing device. In some embodiments, the paper catalog is stored within the digital front end.

In some embodiments, the step of generating the comparison also includes listing a printing condition of the plurality of print conditions along with the respective consumable estimation the overall consumable estimations. In some embodiments, the step of generating the comparison also includes generating a plurality of graphics corresponding to the plurality of print conditions based on the overall consumable estimations. In some embodiments, each graphic of the plurality of graphics reflects a result corresponding to the respective overall consumable estimations.

In additional embodiments, the method also includes receiving a selection of a print condition for the plurality of print conditions within the user interface based on the comparison of the overall consumable estimations. In additional embodiments, the method also includes determining a change in a cost for the job based on the selected print condition and displaying the change in the user interface.

In additional embodiments, the method also includes adjusting a print setting for the job. In additional embodiments, the method also includes updating the initial consumable estimation and the additional consumable estimations for the job based on the adjusted print setting.

A method for managing printing operations using consumable use estimations is disclosed. The method includes performing an initial consumable estimation of a consumable for a job to be printed at a printing device. The job specifies a media. The method also includes identifying a plurality of print conditions corresponding to a paper catalog entry for the media within a paper catalog accessible by the printing device. The plurality of print conditions includes an initial print condition corresponding to the initial consumable estimation. The method also includes determining additional consumable estimations for the media corresponding to the plurality of print conditions based on information within the paper catalog entry. The method also includes determining at least one print condition of the plurality of print conditions having an additional consumable estimate within a threshold from the initial consumable estimation. The method also includes generating a comparison of overall consumable estimations including the initial consumable estimation for the initial print condition and the additional consumable estimations for the at least one print condition. The method also includes displaying the comparison of the overall consumable estimations including the initial consumable estimation and the at least one additional consumable estimation within a user interface for the printing device.

In some embodiments, the threshold is above the initial consumable estimation. In other embodiments, the threshold is below the initial consumable estimation. In some embodiments, the consumable is ink. In other embodiments, the consumable is toner. In some embodiments, the step of generating the comparison includes listing a print condition of the plurality of print conditions along with the respective consumable estimation of the overall consumable estimation.

A printing system is disclosed. The printing system includes a printing device having a digital front end (DFE). The printing system also includes a paper catalog for the printing device accessible by the DFE. The printing system also includes a user interface for the printing device. The printing system also includes a processor communicatively coupled to a memory storing instructions, wherein the instructions, when executed by the processor, configures the processor to perform an initial consumable estimation of a consumable for a job to be printed at the printing device. The job specifies a media. The processor also is configured to identify a plurality of print conditions corresponding to a paper catalog entry for the media within the paper catalog accessible by the printing device. The processor also is configured to determine additional consumable estimations for the media corresponding to the plurality of print conditions based on information within the paper catalog entry. The processor also is configured to generate a comparison of overall consumable estimations including the initial consumable estimation and the additional consumable estimations. The processor also is configured to display the comparison of the overall consumable estimations includes the initial consumable estimation and the additional consumable estimations within the user interface for the printing device.

In some embodiments, the processor and the memory are located within the DFE.

### BRIEF DESCRIPTION OF DRAWINGS

Various other features and attendant advantages of the present invention will be more fully appreciated when considered in conjunction with the accompanying drawings.

FIG. 1A illustrates a printing system for printing documents according to the disclosed embodiments.

FIG. 1B illustrates a digital front end (DFE) for a printing device according to the disclosed embodiments.

FIG. 2 illustrates a block diagram of components of the printing device for use within the printing system according to the disclosed embodiments.

FIG. 3 illustrates a block diagram of a paper catalog for use within the printing system according to the disclosed embodiments.

FIG. 4 illustrates a process flow diagram of the selection of a RIP from the plurality of RIPs in the offline estimation device according to the disclosed embodiments.

FIG. 5 illustrates a block diagram of configuration settings within the configuration setting information and the color printing resources retrieved by the offline estimation device according to the disclosed embodiments.

FIG. 6 illustrates a flow diagram for providing multiple consumable use estimates for a media based on print conditions according to the disclosed embodiments.

FIG. 7 illustrates a flowchart for performing consumable use estimates in a printing system according to the disclosed embodiments.

FIG. 8 illustrates a flowchart for applying a threshold to the plurality of print conditions according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide an interactive consumable use estimation system that allows users to easily see consumable use estimates for different job processing options. Consumable use may refer to ink use or toner use. At times below, the terms “ink use” or “ink use estimation” may be used, which also may be interchangeable with the terms consumable use, consumable use estimation, toner use, and toner use estimation. Further, consumables may refer to other items used in the printing process.

When the operator elects to perform consumable use estimation for a given job, the printing system may evaluate the media selection for the job and determine if there are multiple calibrations or ICC profiles for the job. When there are multiple calibrations and ICC profiles, the printing system may use the print condition attribute to select between those calibrations and ICC profiles. The disclosed embodiments leverage that functionality. If so, then the disclosed embodiments perform consumable use estimation for all of the available profiles. The printing system may retain consumable use estimation results for each of the available calibrations and profiles.

The disclosed embodiments then may present enhanced consumable use information in one or more of the following actions. In the consumable use estimation results, the disclosed embodiments may present the usual consumable use results to the operator. The disclosed embodiments, however, also may present a list of print conditions with the default print condition selected. The operator will have the option to change print conditions and to see changes in consumable use and costs. The disclosed embodiments may present results of all print conditions in a single chart that would allow users to directly compare the consumable use for each of the available options without having to make any selections in the user interface. The printing system may present a gallery or consumable use results to the operator that would allow the operator to browse through the different consumable use results.

In instances in which consumable use estimates are shown one at a time, the printing system will show results for the print condition used with the current job. The disclosed embodiments, however, may recommend print conditions that area higher or lower versus the selected print condition if the consumable use falls within a certain threshold of the default print condition.

Further, the disclosed embodiments may allow the operator to update print settings in order to adjust consumable use. This feature may include print quantity or the total number of sheets. This feature also may include color reproduction adjustments such as tone reproduction curves (TRCs) and hue lightness saturation (HLS) changes. Although these adjustments may require redoing of the simulation, which may be more effort than paper ICC color conversion, this color conversion may be done in the hardware that would support interactively updating consumable use information in response to operator changes to these settings.

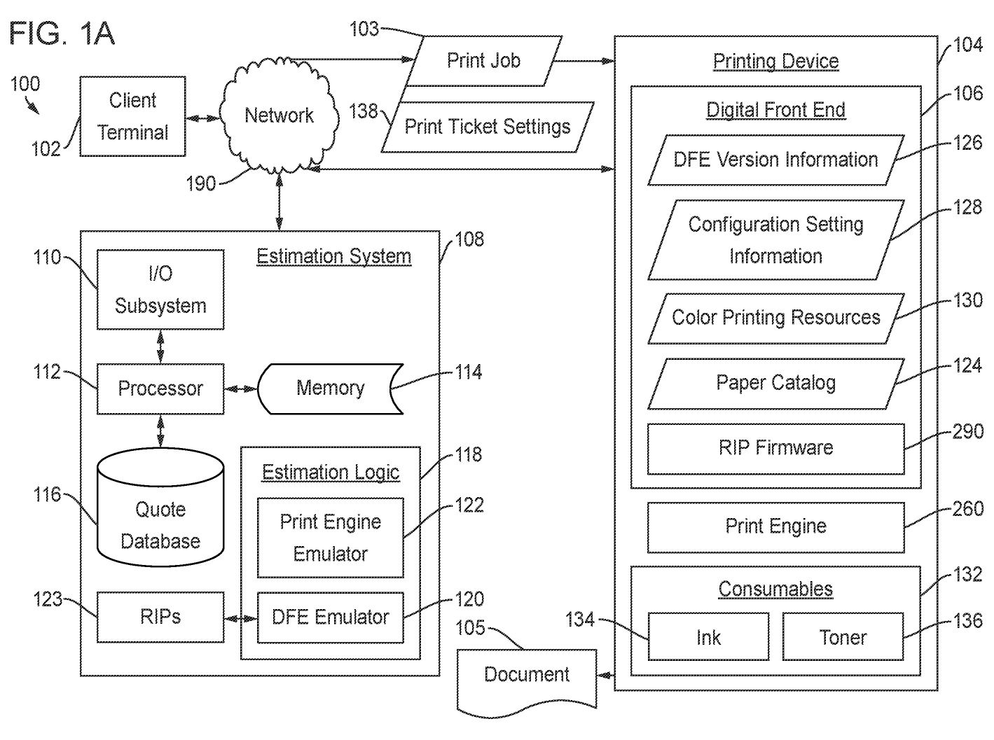

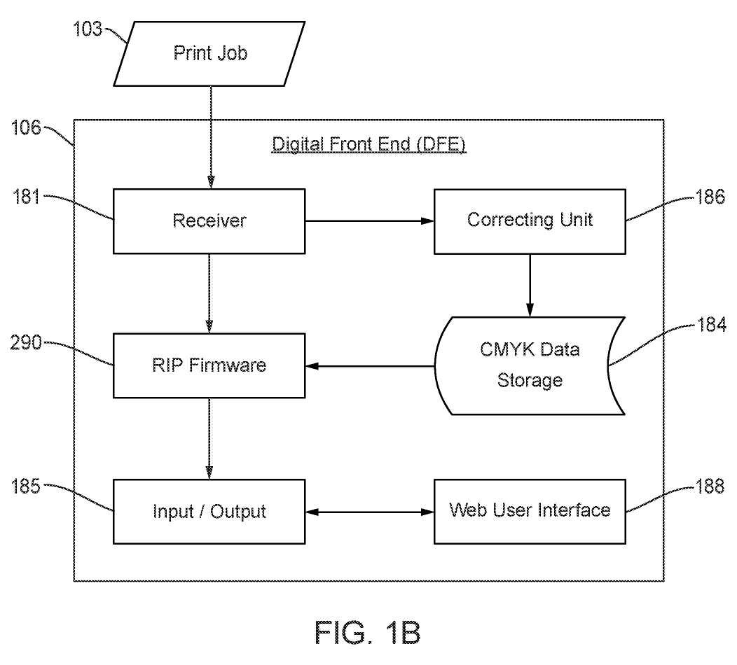

FIG. 1A depicts a printing system 100 for printing documents using printing device 104 according to the disclosed embodiments. Printing system 100 may be located in a print shop or other environment suitable for production printing operations. Printing system 100 includes one or more printing devices 104 that receive print jobs from one or more client devices 102.

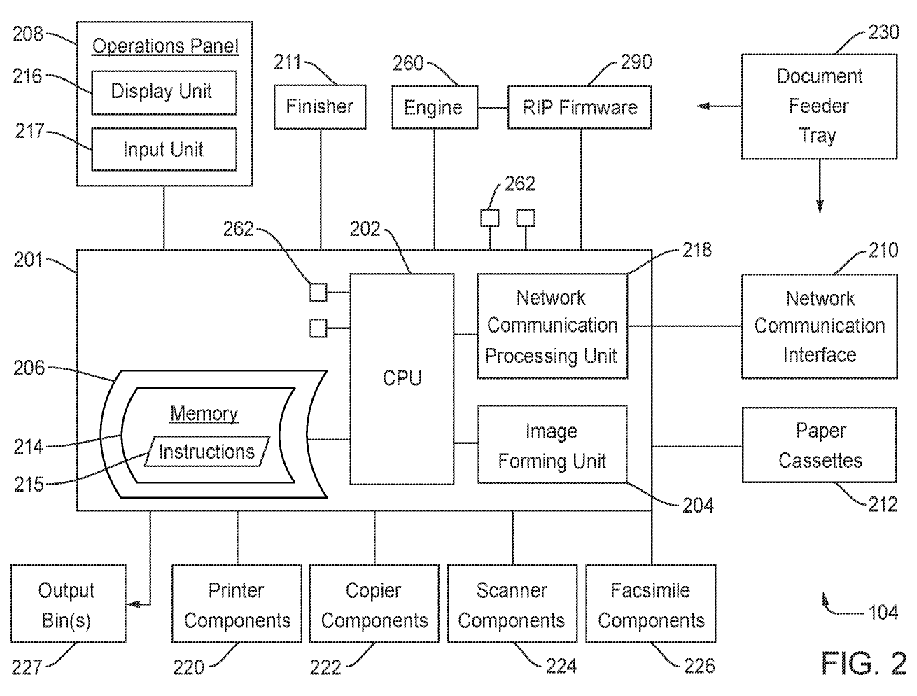

Printing device 104 receives print jobs through printing system 100. It may receive print job 103. After processing print job 103, printing device 104 prints or produces document 105 in a paper or media specified by the print job. Printing device 104 is disclosed in greater detail in FIG. 2. Printing device 104 also includes digital front end (DFE) 106, which facilitates processing print job 102. DFE 106 may be disclosed in greater detail in FIG. 1B. In addition to the components of DFE 106 disclosed in FIG. 1B, it also includes various functionality that may be used for consumable use estimation. This information includes DFE version information 126, configuration setting information 128, and color printing resources 130. DFE 106 also includes RIP firmware 290, disclosed in greater detail below.

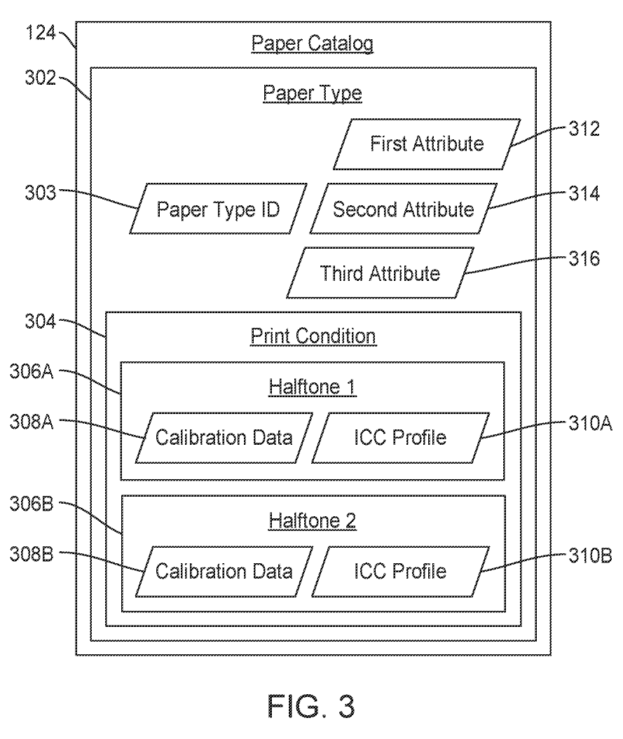

DFE 106 also includes paper catalog 124. Paper catalog 124 is configured to organize and store existing calibration data and ICC profiles for a plurality of papers. Upon selection of a paper for printing at printing device, paper catalog 124 may be accessed to complete print job 103 according to the expectations associated with the print job. Paper catalog 124 is disclosed in greater detail below by FIG. 3. In some embodiments, DFE 106 may include multiple paper catalogs. Further, paper catalog 124 also may be stored in another component within printing system 100 and accessible by DFE 106.

Printing device 104 also includes consumables 132. Consumables 132 may relate to items at or within printing device 104 but are not actually part of the printing device itself. Consumables 132, however, are used in printing operations. Consumables 132 include ink 134 and toner 136. Ink 134 and toner 136 further may be broken into different colorant inks. For example, ink 134 may include cyan ink, magenta ink, yellow ink, and black ink. If printing device 104 is not capable of color printing, then ink 134 may include only black ink. Printing device 104 may include other consumables 132, such as sheets, that are not disclosed in detail herein.

Print job 103, when printed on printing device 104, uses an amount of consumables 132 to produce document 105. In some embodiments, print job 103 produces thousands or more of a document. Thus, the amount of consumables used for print job 103 may be considerable. As disclosed above, printing system 100 may need to provide an estimate for the use of consumable 132. The estimate determined for print job 103 may depend on various settings of printing device 104. The settings as well as print ticket settings 138 associated with print job 103 impact the amount of consumables 132 used to generate document 105.

For example, DFE 106 may use RIP firmware 290 to convert bitmap images, vector graphics, fonts, and the like associated with pages in print job 103 to bitmap/rasterized representations of the pages, such and C, M, Y, and K pixels. The sum of the values of pixels of a particular color in the rasterized pages can be proportional to the amount of consumables 132 used by printing device 104 to print that color. RIP firmware 290 may rasterize pages of print job 103 according to various image rasterization settings, as captured by configuration setting information 128. For example, these image rasterization parameters may include calibration curves, paper definitions, ICC profiles, spot color definitions, TRCs, color conversion settings, colorant limits for ink or toner, rendering intent, K preservation, CGR level, max colorant densities, print margins, halftones, spot color processing, overprint, knockout, and the like.

To lower printing device consumable usage, RIP firmware 290 may be configured via image rasterization parameters of configuration setting information 128 to reduce the density for each colorant, convert color images to black and white, and adjust tone reproduction curves (TRCs) to lower printing device use of consumables 132. Gray component replacement levels may be adjusted via configuration setting information 128. Color printing resources 130 may be configured to change how colors are converted for printing to thereby reduce usage of consumables 132.

The disclosed embodiments also include an estimation system 108 that includes estimation logic to facilitate performance of ink use estimation. Estimation system 108 may include estimation logic 118 having a DFE emulator 120 and a print engine emulator 122 configured to emulate operations performed by DFE 106 and print engine 260 of printing device 104. Print engine 260 is disclosed in greater detail below. DFE emulator 120 and print engine emulator 122 may be configured with configuration setting information 128 to match settings associated with printing device 104. Estimation logic 118 also may be configured to estimate the amount of consumables 132 to process print job 103 and produce document 105.

In operation, estimation logic 118 may monitor information and settings of printing device 104 to determine any differences from previous estimates. This feature facilitates real-time configuration information for DFE 106, RIP firmware 290, or print engine 260 with the corresponding settings utilized by printing device 104.

Printing device 104 may include other settings within configuration setting information 128, such as printing device maintenance settings that may control or impact head cleaning intervals, head clogging prevention intervals, spitting, or printing spray patterns over all content, the printing of purge sheets or inkjet purge options, the printing of spit lines, or lines printed between page frames in a roll-fed printing device to ensure that all jets of the print head fire accordingly, and the like.

Estimation system 108 may be any system or device within system 100 and connected to network 190 to receive and send data to printing device 104. Estimation system 108 also may be connected to other printing devices within system 100. Preferably, estimation system 108 may be server. It also may be another device, such as a computer. Estimation system 108 includes a memory 114 and a processor 112. Estimation system 108 also includes an input/output (I/O) subsystem 110 and a quote database 116.

Estimation system 108 also may refer to consumable estimation software that executes on a device. As disclosed below, “estimation system” may refer to this software.

Processor 112 is in communication with memory 114. Processor 112 is configured to execute instruction code in memory 114. The instruction code controls offline estimation device 108 to perform various operations for estimating consumables 132 that may be used by printing device 104. Processor 112 may be a computer processing unit that executes the instruction code in memory 114.

I/O subsystem 110 may include one or more input, output, or input/output interfaces that are configured to facilitate communications with other devices within system 100, such as client terminal 102 and printing device 104. An example of I/O subsystem 110 may be configured to dynamically determine the communication methodology utilized by entities of system 100 to communication information thereto. For example, I/O subsystem 110 may determine that a first entity utilizes a RESTful API and can, as a result, communicate with the entity using an interface that uses a RESTful communication methodology.

Estimation logic 118 is implemented within estimation system 108 to estimate the amount of consumables 132 to be used by printing device 104 for printing document 105 of print job 103. Estimation logic 118 includes DFE emulator 120 and print engine emulator 122, as disclosed above. DFE emulator 120 and print engine emulator 122 are configured with configuration setting information 128 to match the settings and parameters of printing device 104.

DFE emulator 120 may be configured to emulate operations performed by DFE 106 of printing device 104. The emulation depends on various settings specified for printing device 104. For example, DFE emulator 120 may be configured to convert bitmap images, vector graphics, fonts, and the like specified in sample pages of print job 103 to bitmap/rasterized representations of the pages using C, M, Y, and K pixels. The manner in which DFE emulator 120 performs the conversion may depend on various image rasterization settings of the DFE emulator, which correspond to the image rasterization settings of DFE 106.

In some embodiments, DFE emulator 120 retrieves a RIP of the plurality of RIPs 123 available at estimation system 108. Selection of the appropriate RIP provides a better basis to estimate ink use. For example, estimation logic 118 may determine the DFE software version from DFE version information 126 to select a RIP that has the same version. Estimation system 108 includes many different RIPs 123. Preferably, it includes one for each software version that has been released. DFE emulator 120 may automatically configure the selected RIP using configuration settings from configuration setting information 128. The configuration of the RIP is enabled in real time and for different RIP instances.

The RIP configured by estimation system 108 may use these settings to adjust how print job 103 is image processed and also to adjust how consumables 132 is calculated from the rasterized image data. Estimation logic 118 also may push color printing resources 130 to the selected RIP of RIPs 123 so that it matches the printing device’s configuration. Once the RIP is configured, offline estimation device 108 may perform ink use estimation. After the estimation is complete, estimation system 108 may verify production by comparing the consumable estimate to a previous estimate. This process would not just include printing device settings but also includes print ticket settings 138 that impact ink use.

Estimation system 108 also may be located on printing device 104. Estimation system 108 may communicate directly with DFE 106, especially paper catalog 124. Estimation system 108 also may use any user interface or display for printing device 104 to provide information to the operator about job 103. Further, any consumable estimations generated by estimation system 108 may be displayed at printing device 104 or any other device within printing system 100.

FIG. 1B depicts a block diagram of DFE 106 according to the disclosed embodiments. DFE 106 includes a receiver 181, an RIP firmware 290, a CMYK data storage 184, an input/output connector 185, and a correcting unit 186. RIP firmware 290 also is disclosed in FIG. 2 and in greater detail in FIG. 3. Additional components within DFE 106 may be implemented, including those disclosed in FIG. 1A. DFE 106, therefore, includes data for DFE version information 126 and configuration setting information 128, even though these are not shown in FIG. 1B.

Receiver 181 receives print job 103 received within system 100 and outputs the print job to RIP firmware 290. Receiver 181 also may receive color information for the document or documents within the print job. It may output the color information to correcting unit 186. The print job received by receiver 181 is associated with image data to be printed on print media. It also may include print condition information including information for indicating single-sided printing or two-sided printing or print medium-type information along with other data associated with the print job.

RIP firmware 290 converts image data associated with the print job into raster data to thereby generate rendering data, and outputs the generated rendering data. RIP firmware 290 also converts the rendering data into rendering data in a CMYK format. When the rendering data is originally in the CMYK format, or CMYK rendering data, the conversion may not be performed. RIP firmware 290 may perform gradation conversion of the CMYK rendering data, with reference to one or more tone reproduction curves (TRCs). A TRC refers to data indicating the relationship between a colored gradation value for rendering data and print color, or print density, on a given print medium.

When print color provided by printing device 104 alters over time, the TRCs stored in CMYK data storage 184 may be each deviated from an actually measured relationship between a colored value and print color. When the TRC is shifted from the actual relationship, gradation conversion for each colored gradation value cannot match a desired print color. In this regard, correcting unit 186 corrects the deviation, from the actual relationship, of the TRC stored in CMYK data storage 184 in order to allow each colored gradation value to match a desired print color. Correcting unit 186 converts RGB color information obtained through receiver 181 into CMYK color information. Correcting unit 186 may use the converted CMYK color information to generate the TRC. The TRC stored in CMYK data storage 184 is replaced with the generated TRC. Correcting unit 186 may correct the TRC. Correcting unit 186 may rewrite a part of the TRC stored in CMYK data storage 184 to thereby correct the TRC.

The rendering data generated by RIP firmware 290 is transmitted within printing device 104 via input/output connector 185. The print condition information and the print medium type, as well as the rendering data, may be transmitted to engine 260 found in printing device 104 disclosed in FIG. 2.

DFE 106 also includes web user interface 188 that may communicate with other printing devices or estimation system 108, if it is located at a separate device, using, for example, input/output connector 185. Web user interface 188, or web application, allows a user of the DFEs of other printing devices to interact with content or software running on DFE 106.

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within system 100. As disclosed above, printing device 104 may send and receive data from estimation system 108, if a separate device, and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays. Paper cassettes 212 may include papers having various sizes, colors, composition, and the like. Papers or media within paper cassettes 212 may be considered “loaded” onto printing device 104. The information for printing these papers may be captured in a paper catalog stored at DFE 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from estimation system 108, if applicable. Estimation system 108 may send ink use estimation data to printing device 104 for display. For example, the operator at printing device 104 may request an estimate for a received print job 103. Printing device 104 requests an estimate for consumables 132 according to the disclosed embodiments.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. Raster image processor (RIP) firmware 290 that interprets the page description languages (PDLs) would transmit and send instructions down to the lower-level engine 260 for actual rendering of an image and application of the ink onto paper during operations on printing device 104. RIP firmware 290 may be located in DFE 106, as disclosed above.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device.

Memory unit 206 may store the history of failure events and occurred errors with a timestamp of each error. Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from offline estimation device 108 as well as other printing devices within system 100.

FIG. 3 depicts a block diagram of paper catalog 124 for use within printing system 100 according to the disclosed embodiments. As disclosed above, paper catalog 124 may reside within DFE 106 of printing device 104. In other embodiments, paper catalog 124 may reside in another component within printing system 100, such as client device 102 or an external server. For brevity, paper catalog 124 is disclosed below as residing within DFE 106.

For each paper type used for a particular model of printing device 104, there are a set of items that work together to achieve optimal reproduction capabilities. These items may be represented in paper catalog 124. An example of an entry in paper catalog for a paper type 302 may be shown. Paper catalog may include hundreds or thousands of such entries. Paper type 302 may be identified within paper catalog 124 by paper type identification 303. In some embodiments, paper type identification 303 may be a unique symbol or code that identifies paper type 302 within paper groups, disclosed in greater detail below.

Paper type 302 includes print conditions. Print conditions may be applied to print jobs using paper type 302. Examples of print conditions may be high quality, default, ink saving, and the like. Each print condition may include its own color printing resources, such as calibration data and ICC profiles. Application of a print condition results in a different result for a print job using paper type 302 at printing device 104. For example, a high quality print condition will differ in some fashion as a finished, printed document from one printed using the default print condition.

As shown in FIG. 3, paper type 302 may include print condition 304. It also may include additional print conditions. Print condition 304 may relate to the high quality print condition for printing paper type 302 at printing device 104. Within print condition, halftones, or halftone designs, may be defined. Printing device 104 may have one or more halftones. Halftones are binary on/off dot patterns of each ink to mimic continuously varying transitions. One halftone could emphasize details in the image, while another could be best for smooth transitions. Thus, print condition 304 includes halftone 306A and halftone 306B. For example, halftone 306A may correspond to the halftone design to emphasize details in the image being printed. Halftone 306B may correspond to the halftone design to provide for smooth transitions.

For each halftone, the print shop should capture the desired per-colorant behavior over all shades of that colorant. By behavior, the disclosed embodiments refer to the color measurement. The record of these colorant behaviors, and the information that allows printing device 104 to be adjusted back to such behaviors, are stored as calibration data. These adjustments may vary linearly or with a curve. The calibration data include characteristics of each ink under the halftone selected. Thus, halftone 306A includes calibration data 308A and halftone 306B includes calibration data 308B.

Further, with a selected halftone, and the calibration data enforced to produce desired behavior of each colorant, the disclosed embodiments then create an ICC profile to fully characterize how ink combinations relate to standardized color measurements, as disclosed above. It is via the ICC profile that, for the specific paper-halftone-calibration-data set up, printing device 104 can reproduce the colors, text, and parameters of the original document. The process for generating an ICC profile is disclosed above. Thus, halftone 306A includes ICC profile 310A and halftone 306B includes ICC profile 310B.

Often printing systems have additional “dials” for more customized controls. For instance, there are settings of total ink amounts allowed in the ICC profile for preserving the glossy finish of a paper. Alternatively, it could be a very conservative expectation of the black ink response set into the calibration data. These more specific customizations may be identified as print conditions. In the scheme of the aforementioned items affecting color management, the disclosed embodiments place print conditions at the highest tier under each paper type, as shown in FIG. 3 by print condition 304.

Paper type 302 along with print condition 304 and halftones 306A and 306B may refer to the print management resources and items for one paper type. In a print shop, for each model of printing device 104, there may be dozens or more paper types in use. To keep track of the print management items for all these papers, paper catalog 124 may be implemented in system 100. As disclosed above, paper catalog 124 may be a software data storage system that archives all the color management items and resources for each paper type in use. When a print job is specified on a particular paper, identified as paper type identification 303, under a chosen print condition 302 employing halftone 306A, paper catalog 124 will provide the proper corresponding calibration data 308A and ICC profile 310A for printing device 104 to use. If the print job specifies print condition 302 employing halftone 306B, then paper catalog 124 will provide calibration data 308B and ICC profile 310B for printing device 104 to use for the print job.

Paper type 302 also may include one or more attributes for the paper. For example, first attribute 312 may be the weight of a sheet of paper type 302. First attribute 312 may be 120 grams per square meter (gsm). Heavier paper is reflected by a higher number for gsm. Generally, heavier paper is associated with a higher quality of stock. It should be noted that dimensions may also be considered an attribute of paper type 302. Further, first attribute 312 may be considered a dimension of paper type 302.

Paper type 302 also may include second attribute 314 and third attribute 316. These attributes may pertain some other feature of the paper of paper type 302 aside from dimensions and weight. Second attribute 314 may refer to the color of the paper for paper type 302, such as white, blue, yellow, and the like. Third attribute 316 may refer to a feature of the paper of paper type 302, such as recycled, new, and the like. Other potential attributes may be glossy or matte paper.

Dimensions and attributes within paper catalog 124 may not necessarily match the attributes for paper trays 108, 110, and 112. Paper trays 108, 110, and 112 also may have attributes that apply to print job 103 as specified by print ticket 126. Dimensions may be included in print ticket 126. Dimensions also may apply to a parameter within paper catalog 124 and paper trays 108, 110, and 112. The other attributes, however, within paper catalog 124 may not apply to any attribute for paper trays 108, 110, and 112.

In some embodiments, calibrations and ICC profiles may be listed in a paper catalog entry 302 but not associated with a print condition. Further, additional print conditions may be listed for each entry. In other words, the print condition may be null within paper catalog entry 302. For example, paper catalog entry 302 may include print condition 304 as disclosed above. It also may include another set of calibration and ICC profile data, such as calibration 308A or 308B and ICC profile 310A or 310B, that is not associated with a print condition.

Paper catalog entry 302 also may include a second print condition that uses a different calibration but perhaps the same ICC profile as the sets not corresponding to a print condition. Further, paper catalog entry 302 may include another group of printing resources for halftone 306B but this is not related to a print condition and includes its own calibration and ICC profile. In other words, printing resources may be listed in a paper catalog entry 302 in a number of ways. Multiple calibrations and ICC profiles may be tied to an entry. The calibration and ICC profiles may still be tied to the integrated resource management operations disclosed herein.

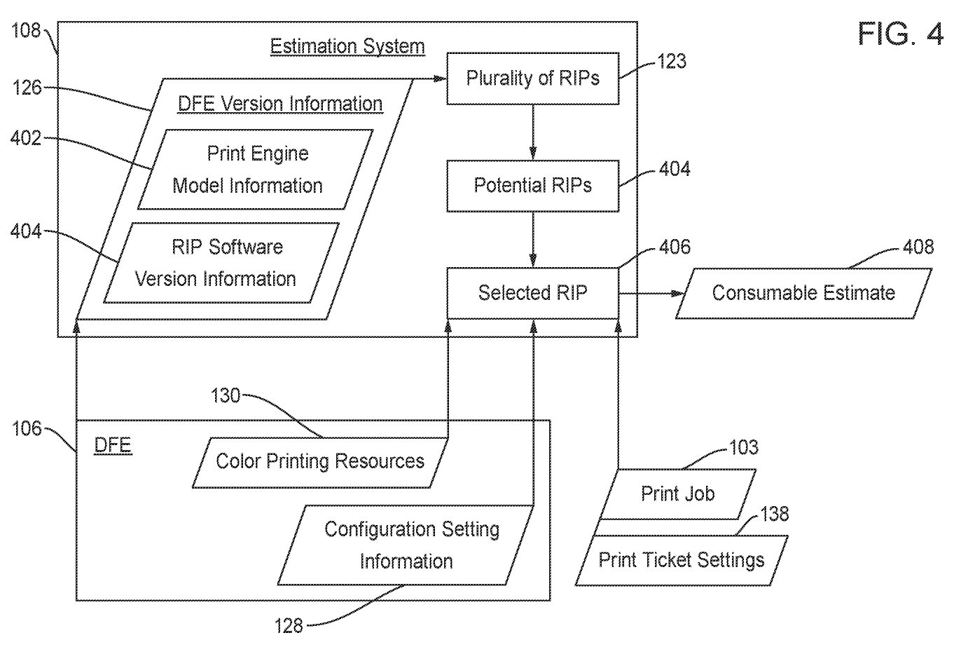

FIG. 4 depicts a process flow diagram of the selection of a RIP from the plurality of RIPs 123 in estimation system 108 according to the disclosed embodiments. Estimation system 108 should select the most appropriate version of the RIP to emulate RIP firmware 290 implemented in DFE 106 of printing device 104. DFE emulator 120 may use this selected RIP to perform estimation of consumables 132 at estimation system 108.

The operations disclosed by FIG. 4 may be implemented in estimation system 108. Estimation system 108 retrieves information about printing device 104 in order to select the appropriate RIP to use in estimating consumable use. Preferably, estimation system 108 receives DFE version information 126 from DFE 106. This information includes print engine model information 402. Different printing devices may use different print engines for printing operations. These different print engines also may utilize different RIPs as well. Within the different RIPs used by the print engine, there may be different versions.

For example, DFE version information 126 may include RIP software version information 404 along with print engine model information 402. Estimation system 108 would select a RIP to match the print engine model and the exact version number. The disclosed embodiments may select between RIPs for different printing devices. For example, the disclosed embodiments may select the MZ8001ic RIP as opposed to the TASKalfaPro 15000c RIP based on print engine model information 402.

Within printing device 104, the disclosed embodiments also select the exact version of the RIP software, as specified by RIP software version information 404. For example, within printing device 104 may be a print engine 260 associated with the TASKalfaPro 15000c model. There may be five different software versions for this DFE that have been released to the market. The disclosed embodiments retrieve the version number from RIP software version information 404 to process the print job using the exact version that printing device 104 uses.

Using DFE version information 126, estimation system 108 queries plurality of RIPs 123 to generate potential RIPs 494. These potential RIPs may be the different software versions released for the specific printing device associated with the DFE print engine model information. Estimation system 108 includes many different RIPs and their different versions. Updates to the various RIPs deployed within system 100 may be received at estimation system 108 to make sure plurality of RIPs 123 are kept current. This feature also reduces the need to keep DFE 106 aware of updates to different RIPs that are not related to its RIP firmware 290.

Once potential RIPs are identified, offline estimation device 108 may use RIP software version information 404 to determine the exact version number of the RIP at printing device 104. Alternatively, the disclosed embodiments may use the exact version number of the RIP that is among a plurality of RIPs used as RIP firmware 290. Using this information, selected RIP 406 is determined from potential RIPs 494. In some embodiments, selected RIP 406 may be determined from plurality of RIPs 123 directly without the need for generating potential RIPs 494.

Selected RIP 406 is configured to mirror RIP firmware 290 in printing device 104 using configuration setting information 128. Estimation system 108 may automatically configure selected RIP 406 using the retrieved printing device configuration settings. The configuration settings within configuration setting information 128 is disclosed in greater detail below. Estimation system 108 also may retrieve color printing resources 130 provided from DFE 106. Selected RIP 406 may call upon color printing resources 130 while doing color printing. Color converter 316 may apply these resources to convert the data within the print job into colors applicable to printing device 104.

In order to provide the estimate, selected RIP 406 within estimation system 108 processes print job 103 much like RIP firmware 290. Selected RIP 406 also takes into account print ticket settings 138 for print job 103. As disclosed above, print ticket settings 138 may be settings specific to the print job, such as printing on both sides, specifying draft quality printing, and the like. In other words, print ticket settings 138 may differ between print jobs. Configured selected RIP 406 now can estimate the amount of consumables 132 that would be needed to complete print job 103. Configured selected RIP 406 provides consumable estimate 408 from estimation system 108. The estimate may be sent to other devices within system 100, such as client terminal 102 or printing device 104.

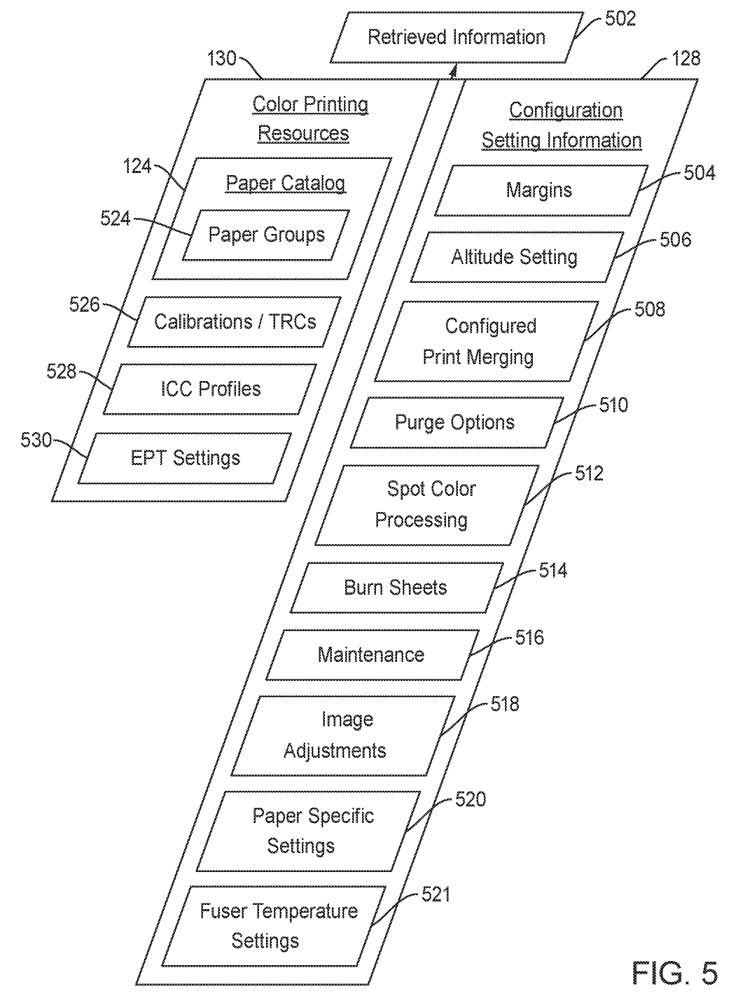

As can be appreciated, any number of configuration settings may be provided in configuration setting information 128 to adapt selected RIP 406 to mirror RIP firmware 290 of printing device 104. Examples of these configuration settings are shown in FIG. 5. The disclosed settings are not exhaustive and may include other settings retrievable from DFE 106 and printing device 104. It should be noted that selected RIP 406 includes components similar to RIP firmware 290 disclosed in FIG. 3.

FIG. 5 depicts a block diagram of configuration settings within configuration setting information 128 and color printing resources 130 retrieved by offline estimation device 108 according to the disclosed embodiments. Retrieved information 502 may represent the data provided by DFE 106 to estimation system 108. Selected RIP 406 is configured accordingly.

Configuration setting information 128 include printing device configuration settings that impact ink and toner use within printing device 104. These settings include margins 504 that are available on printing device 104. Margins 504 may be larger or smaller depending on the printing device and RIP firmware. Margins may be set as defaults or per print job. In addition, margins may be media dependent. For example, in printing device 104, larger paper sizes must use a 4 mm margin that is different than smaller paper sizes which may use margins between 1 and 4 mm. Further, media attributes may constrain margins. For example, certain sheets of specific media may require a minimum margin for printing operations. This information is typically model-specific and should be retrieved with configuration settings information 128.

Another configuration setting may be altitude, or elevation, setting 506. The elevation, for example, above sea level may impact ink use. Some inkjet printing devices include settings related to elevation that may be used to configure selected RIP 406. Using this example, printing device 104 may be configured for one of four different elevations: 0 to 1000m, 1001 to 2000m, 2001 to 3000m, and above 3001m. The heads may need to be changed depending on the altitude of printing device 104. Fuser temperature settings 521 also may be included as printing device specific settings. Fuser temperature settings may be applicable for toner devices, which may impact ink use. Again, maintenance within printing device 104 may depend on these temperature settings.

Configured print merging setting 508 may provide instructions used for print merging. Purge options 510 may represent how often inkjet heads are purged during operations. These actions impact ink use. During large production print jobs, a purge may need to occur during the print job and is part of the ink used to process the print job. Thus, these settings should be retrieved as well.

Spot color processing 512 may provide settings for spot color operations to determine the reproduction capability of printing device 104. Again, these may need to be run periodically during printing operations and possible more than once during large print jobs. Burn sheets 514 also are included. Burn sheets may be printed at specified intervals for more quality testing of printing device 104. These settings are printing device specific and may be done as needed or as specified. Selected RIP 406 is configured with these settings accordingly.

Maintenance settings 516 may related to maintenance on the print heads of printing device 104. These settings may relate to how head maintenance is done. For example, head maintenance may be done by printing purge sheets, as set forth in purge options 510, at specified intervals or by printing a pattern over all printed sheets that is invisible to the human eye. These operations ensure that all jets fire at regular intervals. These actions also impact ink use.

Image adjustments 518 are settings related to magnification adjustments, change dimensions of images, paper scaling, and change positions related to images or graphics within the print job. Printing device 104 may not be able to print an image accurately so that settings help adjusts the image for printing. These also may impact ink use especially if print job 103 include any images. Paper specific settings 520 also are included in configuration setting information 128. Specific papers loaded onto printing device 104 may include their own settings or requirements that affect ink use. For example, ink use may be limited on a specific paper in order to prevent bleeding or over use of ink.

Configuration setting information 128 also may include default CMYK, default gray, and default RGB ICC profiles. It also may include default rendering intent and default simulation ICC profile. The operator may change these default color resources for printing device 104. For example, the default simulation profile may be changed from FOGRA51 to GRACoL 2013, which would impact image quality. In addition, these defaults may be overridden per print job as part of the job settings.

In addition to configuration setting information 128, retrieved information includes color printing resources 130 within DFE 106. These resources may be files stored at DFE 106 that are made available to selected RIP 406 in the event color printing is to take place for print job 103. Color printing resources 130 may not be applied in all instances of printing on printing device 104.

Color printing resources 130 may include paper catalog 124. Paper catalog 124 is disclosed in greater detail above and may be a paper database on DFE 106 that stores attributes of media stock available in the production print shop, or in system 100. Paper catalog 124 may define multiple media attribute combinations and assign unique names to each combination. It also may assign color profiles for each media. It also may select predefined media for submitted print jobs and assign the media to trays at printing device 104. Paper groups 524 also may be included within paper catalog 124. Paper groups 524 may be implicit (defined by the system based on rules) or explicit (defined by the operator).

Color printing resources also include calibrations/TRCs 526 and ICC profiles 528. These are resources to be used for color printing at printing device 104. Preferably, this information is specific to printing device 104. End point target settings 530 also may be used. Other settings include ink limits, total area coverage, and the like. All of these settings and resources impact ink use while processing a print job using RIP firmware 290, so these settings and resources are to be made available to selected RIP 406 within offline estimation device 108. Calibrations/TRCs 526, ICC profiles 528, and EPT settings 530 may be associated with entries within paper catalog 124.

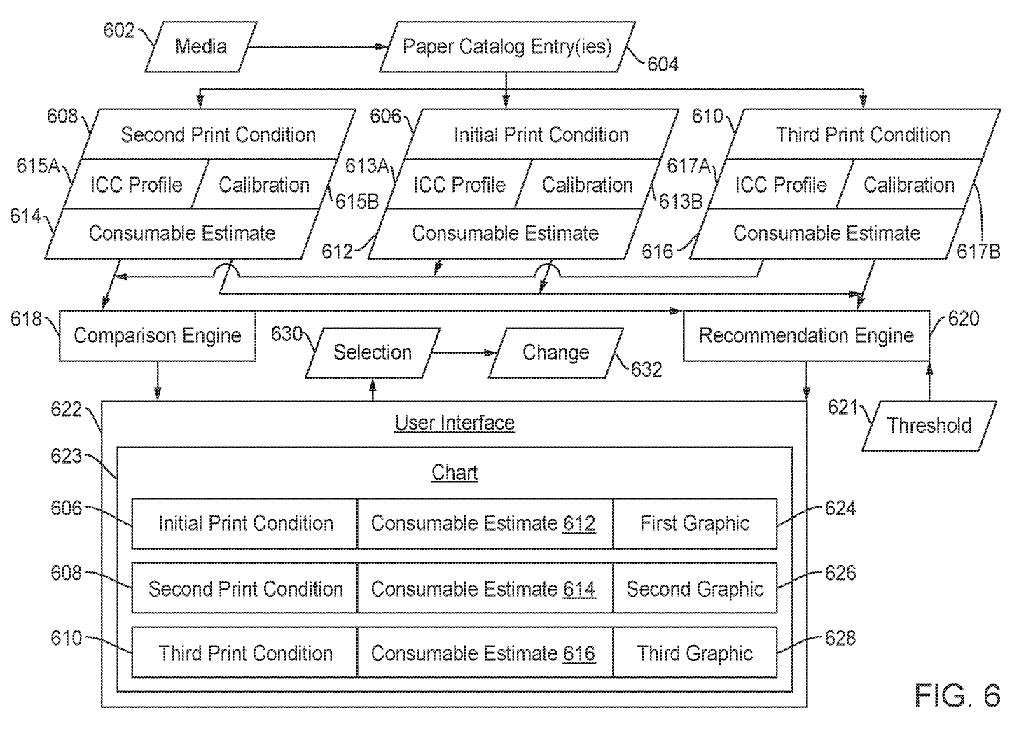

FIG. 6 depicts a flow diagram 600 for providing multiple consumable use estimations for a media 602 based on print conditions according to the disclosed embodiments. When an operator elects to perform consumable use estimation for print job 103, the disclosed embodiments may evaluate the media selection for the job and determine if there are multiple calibrations or ICC profiles within color printing resources 130 for the job. Print job 103 includes selection for media 602 in print ticket settings 138. Media 602 may be a paper or paper type for use to print document 105. For example, media 602 may indicate a glossy, heavy paper having a trade or brand name.

Estimation system 108 may receive media 602 and determine one or more paper catalog entries 604 for the media. Paper catalog entries 604 correspond to paper catalog entry 302 of paper catalog 124. In some instances, only one entry is needed for media 602 in paper catalog 124. Alternatively, multiple paper catalog entries may be identified. Multiple calibrations and ICC profiles may be associated with an entry. The different print conditions in the entry correspond to the different color printing resources. Referring to paper catalog 124, more than one print condition 304 may be associated within an entry.

If there are multiple calibrations and ICC profiles associated with media 602, then estimation system 108 may perform consumable use estimation for all of the available entries and print conditions associated with the calibrations and ICC profiles. Estimation system 108 may retain consumable use estimations for each of the available calibrations and ICC profiles. Consumable use may be estimated for each variation as disclosed above.

The disclosed embodiments, however, may present these different results using the print condition attributes for the entries related to media 602. Thus, an initial, or default, print condition 606 is selected or determined for print job 103. For example, print job 103 may request document 105 to be printed on media 602 at a certain quality level, such as business, as the print condition. Consumable estimate 612 is generated for initial print condition 606, much like consumable estimate 408, by estimation system 108 using ICC profile 613A and calibration 613B applicable to initial print condition 606. For the different calibrations and ICC profiles associated with one or more entries 604, the disclosed embodiments generate additional consumable estimations associated with the respective print condition for the respective calibration and ICC profile.

Thus, second print condition 608 for entry 604 may include a different ICC profile 615A and calibration 615B than initial print condition 606. Estimation system 108 may use ICC profile 615A and calibration 615B in generating consumable estimate 614 for second print condition 608. Consumable estimate 614 should differ from consumable estimate 612. Third print condition 610 for entry 604 also includes a different ICC profile 617A and calibration 617B from those for initial print condition 606 and second print condition 608. Estimation system 108 uses ICC profile 617A and calibration 617B to generate consumable estimate 616 for third print condition 610.

The disclosed embodiments, therefore, generates consumable estimates for a plurality of print conditions applicable to media 602 of print job 103. The different consumable estimates may be compared in comparison engine 618 of estimation system 108. Comparison engine 108 generates the results of all print conditions for display in user interface 622 of printing system 100 or printing device 104. Comparison engine 108 may generate a chart 623 to allow operators to directly compare the consumable use for each available print condition option without having to make additional selections from user interface 622. The operator also would have the option to change print conditions and see the changes in consumable use and costs.

Chart 623 includes initial print condition 606, second print condition 608, and third print condition 610 along with consumable estimate 612, consumable estimate 614, and consumable estimate 616, respectively. These items may be displayed along with graphics that reflect a result for the consumable use estimations. For example, the graphics may indicate a level of consumable use being high, medium, or low, as determined by comparison engine 618. Comparison engine 618 may have ranges for consumable use that correspond to the graphics. Initial print condition 606 may correspond to first graphic 624. Second print condition 608 may correspond to second graphic 626. Third print condition 610 may correspond to third graphic 628.

Recommendation engine 620 may implement a recommendation option for the disclosed embodiments. In instances where consumable use estimates 612, 614, and 616 are shown one at a time, the disclosed embodiments may show results for the respective print condition, such as using first graphic 624, second graphic 626, or third graphic 628, used with the current job. Estimation system 108, however, may recommend print conditions that are higher or lower compared to the selected print condition if the consumable use falls within a certain threshold 621 of the default print condition.

For example, initial print condition 606 may be the default print condition. Consumable estimate 612 is shown along with first graphic 624. Recommendation engine 620 may receive results from comparison engine 618 to determine whether the consumable estimates generated for the other print conditions fall within threshold 621. For example, threshold 621 may be 10% of consumable estimate 612 of initial print condition 606, either above or below the amount. Alternatively, threshold 621 may be a number above or below the amount for consumable estimate 612. Consumable estimate 614 for second print condition 608 may fall within threshold 621 while consumable estimate 616 for third print condition 610 may not. Thus, second print condition 608 and consumable estimate 614 is displayed with initial print condition 606 and consumable estimate 612. Third print condition 610 and consumable estimate 616 may not be displayed.

The disclosed embodiments also may allow the operator to adjust print settings in order to adjust consumable use. The update may include print quantity or the total number of sheets. Consumable use estimates may be changed accordingly and displayed with the respective print conditions. Further, the adjustments may include color reproduction adjustments such as the TRC curve or HLS changes for the end result in document 105. Although these adjustments may require redoing of the simulation for the consumable estimates, which may take longer that a paper ICC color conversion, this color conversion may be done in DFE 106 that would support interactively updating consumable use information in response to operator changes to these settings.

In some embodiments, the operator may select a print condition to apply to print job 103 based on the respective consumable use estimate, shown as selection 630, from user interface 622. A change 632 may be determined for the cost of processing print job 103 using the print condition of selection 630. For example, the operator may select second print condition 608 from user interface 622. Selection 630 is provided DFE 106 and estimation system 108. Change 632 for the overall price of print job 103 may be generated and displayed in user interface 622.

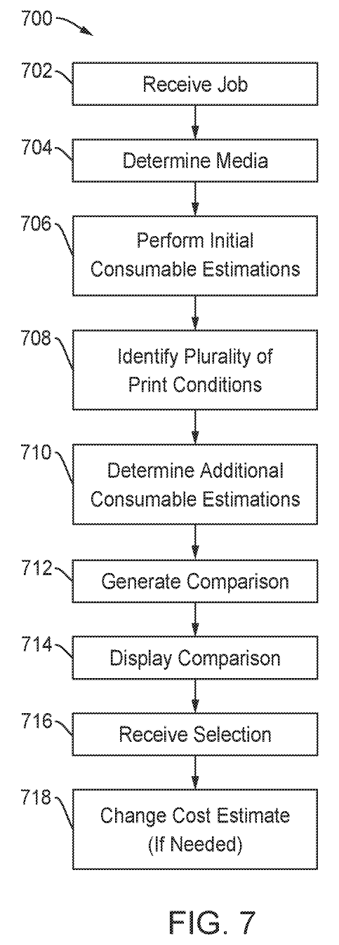

FIG. 7 depicts a flowchart 700 for performing consumable use estimates in a printing system 100 according to the disclosed embodiments. Flowchart 700 may refer to FIGS. 1A-6 for illustrative purposes. Flowchart 700, however, is not limited to the embodiments disclosed by FIGS. 1A-6.

Step 702 executes by receiving print job 103 within printing system 100. A cost estimate is desired for print job 103, which includes a consumable use estimate. Printing system 100 may assign estimation system 108 to determine a consumable use estimate based on settings for print job 103 to print document 105. The cost estimate may be for printing document 105 at printing device 104. Step 704 executes by determining media 602 for print job 103. Media 602 may be specified in print ticket settings 138. Based on media 602, a paper catalog entry 302 may be identified in paper catalog 124 for printing device 104. Part of this determination also is determining whether multiple calibrations or ICC profiles exist for media 602.

Step 706 executes by performing a consumable estimate 612 for initial print condition 606 related to media 602 specified for print job 103. This process is disclosed in detail above. Consumable estimate 612 may be a value related to ink or toner use to print document 105. Step 708 executes by identifying a plurality of print conditions corresponding to paper catalog entry 302 for media 602 within paper catalog 124. In other words, along with initial print condition 606, the paper catalog entry also may include additional print conditions, such as second print condition 608 and third print condition 610, for media 602. In some embodiments, there may be applicable print conditions in other paper catalog entries.

Step 710 executes by determining additional consumable estimates for media 602 corresponding to second print condition 608 and third print condition 610 based on the information for the print conditions in paper catalog 124. For example, estimation system 108 may take into account ICC profile 615A and calibration 615B when determining consumable estimate 614 for second print condition 608. Estimation system 108 also may take into account ICC profile 617A and calibration 617B when determining consumable estimate 616 for third print condition 610.

Step 712 executes by generating a comparison over the overall consumable estimates including consumable estimate 612 for initial print condition 606, consumable estimate 614 for second print condition 608, and consumable estimate 616 for third print condition 610. The comparison may list the print conditions along with the consumable estimates. It also may list the most cost effective consumable estimates along with the estimate for initial print condition 606.

Step 714 executes by displaying the comparison of the print conditions and the respective consumable estimates in user interface 622 for the operator to view. Graphics may be included with the estimates to better show the differences between print conditions. Step 716 executes by printing system 100 or estimation system 108 receiving selection 630 made using user interface 622 of a print condition to apply for print job 103 along with the respective consumable estimate. Step 718 executes by changing a cost estimate for print job 103 to print document 105, if applicable. The operator may select initial print condition as the applicable print condition so that no change needs to be made in the initial cost estimate.

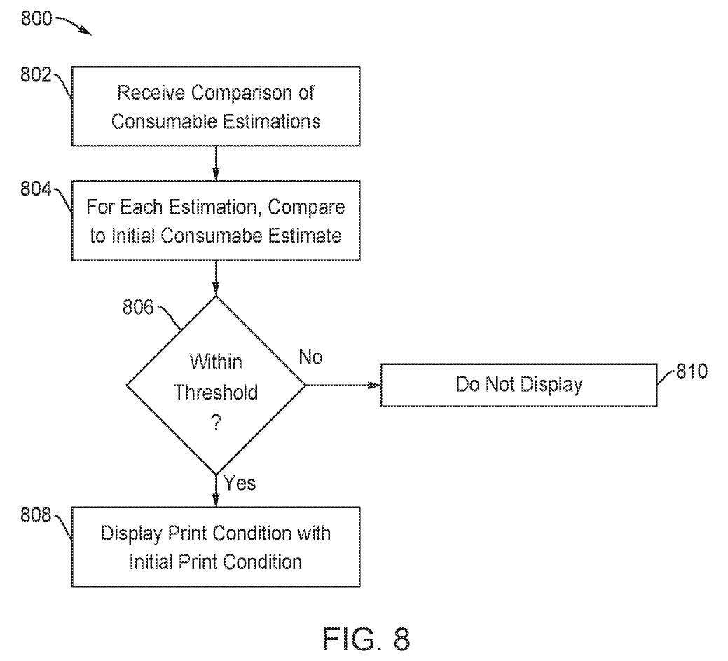

FIG. 8 depicts a flowchart 800 for applying a threshold 621 to the plurality of print conditions according to the disclosed embodiments. Flowchart 800 may refer to FIGS. 1A-7 for illustrative purposes. Flowchart 800, however, is not limited to the embodiments disclosed in FIGS. 1A-7.

Step 802 executes by receiving the comparison of the overall consumable estimations including consumable estimate 612 for initial print condition 606 along with other consumable estimates generated for print conditions associated with media 602. The comparison may be received by recommendation engine 620.

Step 804 executes, for each consumable estimate that is not consumable estimate 612 for initial print condition 606, comparing the respective consumable estimate to consumable estimate 612. For example, consumable estimate 606 may be .15 pL while consumable estimate 614 for second print condition 608 may be .16 pL and consumable estimate 616 for third print condition 610 may be .10 pL. Step 806 executes by determining whether the consumable estimate is within threshold 621. For example, threshold 621 may be 10%. Thus, using the above example, consumable estimate 614 is within threshold 621 while consumable estimate 616 is not.

If step 806 is yes, then step 808 executes by displaying the respective print condition related to the consumable estimate with initial print condition 606 to the operator within user interface 622. If step 806 is no, then step 810 executes by not displaying the print condition associated with the consumable estimate.

In some embodiments, flowchart 800 may be modified to determine whether a consumable estimate is below consumable estimate 612 for initial print condition 606. If so, then the print condition associated with the consumable estimate is displayed without applying threshold 621. The operator is given the option to select print conditions that are cheaper than the initial print condition. Alternatively, only print conditions having consumable estimates higher than the initial print condition may be displayed.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non- exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer- usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for managing printing operations, the method comprising:
performing an initial consumable estimation of a consumable for a job to be printed at a printing device, wherein the job specifies a media;
identifying a plurality of print conditions corresponding to a paper catalog entry for the media within a paper catalog accessible by the printing device;
determining additional consumable estimations for the media corresponding to the plurality of print conditions based on information within the paper catalog entry;
generating a comparison of overall consumable estimations including the initial consumable estimation and the additional consumable estimations; and
displaying the comparison of the overall consumable estimations including the initial consumable estimation and the additional consumable estimations within a user interface for the printing device.

2. The method of claim 1, wherein the consumable is ink.

3. The method of claim 1, wherein the consumable is toner.

4. The method of claim 1, further comprising receiving the job at a digital front end of the printing device.

5. The method of claim 4, wherein the paper catalog is stored within the digital front end.

6. The method of claim 1, wherein generating the comparison includes listing a print condition of the plurality of print conditions along with the respective consumable estimation of the overall consumable estimations.

7. The method of claim 1, wherein generating the comparison includes generating a plurality of graphics corresponding to the plurality of print conditions based on the overall consumable estimations.

8. The method of claim 7, wherein each graphic of the plurality of graphics reflects a result corresponding to the respective overall consumable estimations.

9. The method of claim 1, further comprising receiving a selection of a print condition for the plurality of print conditions within the user interface based on the comparison of the overall consumable estimations.

10. The method of claim 9, further comprising determining a change in a cost for the job based on the selected print condition and displaying the change in the user interface.

11. The method of claim 1, further comprising adjusting a print setting for the job.

12. The method of claim 11, further comprising updating the initial consumable estimation and the additional consumable estimations for the job based on the adjusted print setting.

13. A method for managing printing operations using consumable use estimations, the method comprising:
performing an initial consumable estimation of a consumable for a job to be printed at a printing device, wherein the job specifies a media;
identifying a plurality of print conditions corresponding to a paper catalog entry for the media within a paper catalog accessible by the printing device, wherein the plurality of print conditions includes an initial print condition corresponding to the initial consumable estimation;
determining additional consumable estimations for the media corresponding to the plurality of print conditions based on information within the paper catalog entry;
determining at least one print condition of the plurality of print conditions having an additional consumable estimate within a threshold from the initial consumable estimation;
generating a comparison of overall consumable estimations including the initial consumable estimation for the initial print condition and the additional consumable estimations for the at least one print condition; and
displaying the comparison of the overall consumable estimations including the initial consumable estimation and the at least one additional consumable estimation within a user interface for the printing device.

14. The method of claim 13, wherein the threshold is above the initial consumable estimation.

15. The method of claim 13, wherein the threshold is below the initial consumable estimation.

16. The method of claim 13, wherein the consumable is ink.

17. The method of claim 13, wherein the consumable is toner.

18. The method of claim 13, wherein generating the comparison includes listing a print condition of the plurality of print conditions along with the respective consumable estimation of the overall consumable estimations.

19. A printing system comprising:
a printing device having a digital front end (DFE);
a paper catalog for the printing device accessible by the DFE;
a user interface for the printing device; and
a processor communicatively coupled to a memory storing instructions, wherein the instructions, when executed by the processor, configures the processor to
perform an initial consumable estimation of a consumable for a job to be printed at the printing device, wherein the job specifies a media;
identify a plurality of print conditions corresponding to a paper catalog entry for the media within the paper catalog accessible by the printing device;
determine additional consumable estimations for the media corresponding to the plurality of print conditions based on information within the paper catalog entry;
generate a comparison of overall consumable estimations including the initial consumable estimation and the additional consumable estimations; and
display the comparison of the overall consumable estimations including the initial consumable estimation and the additional consumable estimations within the user interface for the printing device.

20. The printing system of claim 19, wherein the processor and the memory are located within the DFE.
